(19) United States
(12) Patent Application Publication
(10) Pub. No.: US 2005/0162085 A1
(43) Pub. Date: Jul. 28, 2005

(54) Plasma display panel and its aging method

(76) Inventors: Masaaki Yamauchi, Osaka (JP); Takashi Aoki, Osaka (JP); Akihiro Matsuda, Osaka (JP); Koji Akiyama, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/510,977

(22) PCT Filed: Feb. 18, 2004
(86) PCT No.: PCT/JP04/01762

(30) Foreign Application Priority Data
Feb. 19, 2003 (JP) 2003-041126

(51) Int. Cl. H01J 17/49

(52) U.S. Cl. 313/583; 313/584; 313/582

(57) ABSTRACT

In the aging process in which a voltage having an alternate voltage component is applied to at least between scan electrode (5) and sustain electrode (6) so as to form a discharge dent (sputter dent) on the protecting layer, the aging discharge dent is formed so as to satisfy any one of the followings. Firstly, the discharge dent on the scan electrode-side has a width narrower than the discharge dent on the side of sustain electrode (6). Secondly, the discharge dent on the side of sustain electrode (6) is formed so that the depth of the discharge dent in the area away from scan electrode (5) paired with sustain electrode (6) as a display electrode is shallower than the depth of the discharge dent in the area close to counterpart scan electrode (5).

### TECHNICAL FIELD

The present invention relates to an alternative current (AC) plasma display panel and a method of aging the same.

### BACKGROUND ART

A plasma display panel (hereinafter referred to as a PDP or simply a panel) is a display device with an excellent visibility, large screen, and low-profile, lightweight body. The difference in discharging divides PDPs into two types of the alternative current (AC) type and the direct current (DC) type. In terms of the structure of electrodes, the PDPs fall into the 3-electrode surface discharge type and the opposing dscharge type. In recent years, the dominating PDP is the AC type 3-electrode surface discharge PDP by virtue of having higher resolution and easier fabrication.

Generally, the AC type 3-electrode surface discharge PDP contains a front substrate and a back substrate oppositely disposed with each other, and a plurality of discharge cells therebetween. On a front glass plate of the front substrate, scan electrodes and sustain electrodes as display electrodes are arranged in parallel with each other, and over which, a dielectric layer and a protecting layer are formed to cover the display electrodes. On the other hand, on a back glass plate of the back substrate, data electrodes are disposed in a parallel arrangement, and over which, a dielectric layer is formed to cover the electrodes. On the dielectric layer between the data electrodes, a plurality of barrier ribs is formed in parallel with the rows of the data electrodes. Furthermore, phosphor layer is formed between the barrier ribs and on the surface of the dielectric layer. The front substrate and the rear substrate are sealed with each other so that the display electrodes are orthogonal to the data electrodes in the narrow space between the two substrates. The narrow space, i.e., the discharge space is filled with discharge gas. The panel is thus fabricated.

Such a panel just finished, however, generally exhibits a high voltage at the start of discharging, and the discharge itself is in an unstable condition. The panel is therefore aged in the manufacturing process to obtain consistent and stable discharge characteristics.

Conventionally, a method—in which an anti-phased rectangular wave, that is, voltage having an alternate voltage component is applied to a display electrode, i.e., between a scan electrode and a sustain electrode for a long period of time—has been employed for aging panels. To shorten the aging time, some methods have been suggested. For example, Japanese Patent Non-Examined Publication No. H07-226162 introduces the method in which a rectangular wave is applied, via an inductor, to the electrodes of a panel. On the other hand, Japanese Patent Non-Examined Publication No. 2002-231141 suggests the method as a combination of two kinds of discharging. According to the method, pulse voltage having different polarity is placed between a scan electrode and a sustain electrode (i.e., discharging in the same surface) and consecutively, pulse voltage having different polarity is now placed between the display electrodes and the data electrodes (i.e., discharging between the opposite surfaces).

Performing an aging process, as is known in the art, thins the surface of the protecting layer due to sputtering. However, an excessively strong aging provides the surface of the protecting layer with an excessive sputtering, thereby shortening the panel life.

The present invention addresses the problem above. It is therefore an object of the invention to provide a long-life panel with minimized aging and the efficient aging method.

### DISCLOSURE OF THE INVENTION

To achieve the object above, the present invention provides the following features. The aging process is performed on a plasma display panel having a plurality of pairs of the scan electrode and the sustain electrode as the display electrode, a dielectric layer covering the electrodes, a protecting layer disposed over the dielectric layer. In the aging process, an aging discharge is performed by applying voltage having an alternate voltage component at least between the scan electrode and the sustain electrode in order to form a discharge dent on the protecting layer. According to the present invention, the aging discharge dent is formed so as to satisfy any one of the followings: first, the discharge dent on the scan electrode-side has a width narrower than the discharge dent on the sustain electrode-side. Secondly, the discharge dent on the sustain electrode-side is so formed that the depth of the discharge dent in the area away from the scan electrode paired with the sustain electrode as a display electrode is shallower than the depth of the discharge dent in the area close to the counterpart scan electrode.

### BRIEF DESCRIPTION OF THE DRAWINGS

FIG. 1 is an exploded perspective view illustrating the structure of a panel of an exemplary embodiment of the present invention.

FIG. 2 shows the arrangement of the electrodes of the panel of the embodiment.

FIG. 3A schematically shows the discharge dent formed on the panel after the aging process.

FIG. 3B schematically shows the discharge dent essential to lower and stabilize the voltage at the start of the sustaining discharge.

FIG. 3C schematically shows the discharge dent essential to lower and stabilize the voltage at the start of the writing discharge.

FIG. 3D schematically shows a depth distribution of the discharge dent formed on the panel of the embodiment.

FIG. 4A shows an aging waveform to form an asymmetric discharge dent of the embodiment.

FIG. 4B shows another aging waveform to form an asymmetric discharge dent of the embodiment.

FIG. 4C schematically shows light emission of a panel in the form of a waveform detected by a photo sensor.

### DETAILED DESCRIPTION OF CARRYING OUT OF THE INVENTION

The exemplary embodiments of the present invention are described hereinafter with reference to the accompanying drawings.

### EXEMPLARY EMBODIMENT

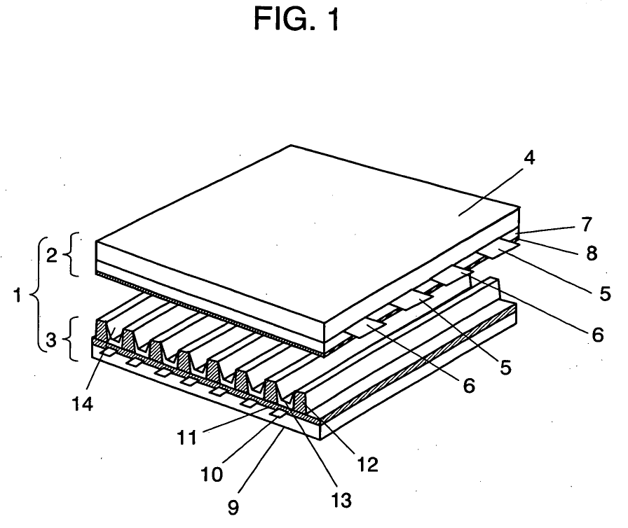

FIG. 1 is an exploded perspective view illustrating the structure of a panel of an exemplary embodiment of the present invention. Panel 1 contains front substrate 2 and back substrate 3 in a confronting arrangement. On front glass plate 4 of front substrate 2, a plurality of pairs of scan electrodes 5 and sustain electrodes 6 is arranged in parallel. The array of scan electrodes 5 and sustain electrodes 6 are covered with dielectric layer 7, and over which, protecting layer 8 is formed to cover dielectric layer 7. On the other hand, on back glass plate 9 of back substrate 3, a plurality of data electrodes 10 is disposed in a parallel arrangement, and over which, dielectric layer 11 is formed to cover electrodes 10. On dielectric layer 11, a plurality of barrier ribs 12 is formed in parallel with the rows of data electrodes 10. Furthermore, phosphor layer 13 is formed between barrier ribs 12 and on the surface of dielectric layer 11. Discharge space 14 between front substrate 2 and back substrate 3 are filled with discharge gas.

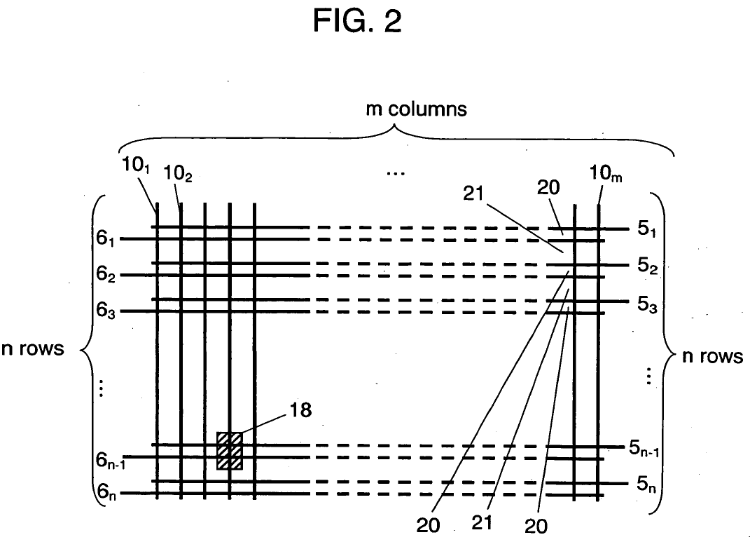

FIG. 2 shows the arrangement of electrodes of panel 1 of the embodiment. m data electrodes 10₁-10ₘ (corresponding to data electrodes 10 shown in FIG. 1) are arranged in a direction of rows. On the other hand, in a direction of columns, n scan electrodes 5₁-5ₙ (scan electrodes 5 of FIG. 1) and n sustain electrodes 6₁-6ₙ (sustain electrodes 6 of FIG. 1) are alternately disposed. The array of the electrodes above forms m×n discharge cells 18 in the discharge space. Each of cells 18 contains a pair of scan electrode 5ᵢ and sustain electrode 6ᵢ (i takes 1 to n) and one data electrode 10ⱼ (takes 1 to m). Scan electrode 5ᵢ is connected to corresponding electrode terminal section 15ᵢ disposed around the perimeter of the panel. Similarly, sustain electrode 6ᵢ is connected to sustain electrode terminal section 16ᵢ; and data electrode 10ⱼ is connected to data electrode terminal section 17ⱼ. Here, the gap formed between scan electrode 5 and sustain electrode 6 for each of cells 18 is referred to as discharge gap 20, and the gap formed between the discharge cells, i.e., between scan electrode 5ᵢ and sustain electrode 6ᵢ₋₁ that belongs to the next discharge cell is referred to as adjacent gap 21.

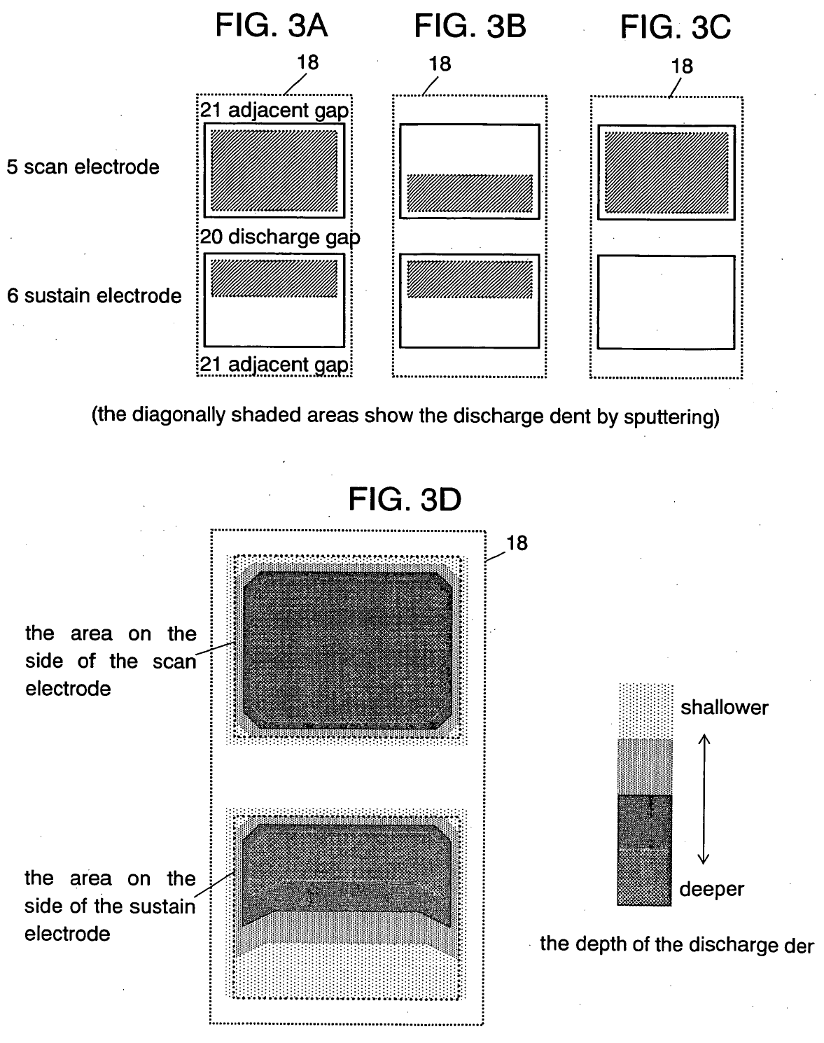

After completion of the aging process, the inventors dissembled a panel and observed a discharge dent (i.e., the dent formed by sputtering in the aging process). FIG. 3A schematically shows the discharge dent (the diagonally shaded areas) on the surface of the protecting layer. As shown in the figure, on the side of the scan electrode 5, the discharge dent covers almost all over the width of scan electrode 5, whereas on the side of sustain electrode 6, the discharge dent localizes in the area close to the counterpart scan electrode 5 as a display electrode, that is, in the area on the side of discharge gap 20. That is, the discharge dent formed on the side of sustain electrode 6 is narrower in width than that formed on the side of scan electrode 5.

The aging process provides, as described above, the surface of protecting layer 8 with sputtering. However, the sputtering amount is very small, the discharge dent by the aging process rarely can be found under an ordinary optical microscope. The observation of the discharge dent is done by a scanning electron microscope (SEM), which is highly sensitive to the shape of matter surface. An SEM scans on the surface of a sample and finds the image of secondary electrons emitted from the surface. The protecting layer is formed of an MgO film. The surface of the film just finished has microscopic asperities less than 100 nm. Through the aging process, the irregular surface is smoothed by sputtering. The amount of secondary electron emission is larger from an inclined or projected surface than a flat surface. In the image of the secondary electron observed under the SEM, the well-sputtered surface of the protecting layer looks dark, whereas the surface with no sputtering or not-enough sputtering looks bright. The discharge dent shown in FIG. 3 is observed by the SEM. Prior to observation by the SEM, it is important that the surface of protecting layer 8 should be coated—since it is insulating material—with a thin film of platinum or gold, in order to protect the surface from being charged up.

Here will be described why the discharge dent is differently formed between the area on the side of scan electrode 5 and the area on the side of sustain electrode 6.

In a sequence of initial, writing, and sustaining discharge of the 3-electrode PDP in operation, the writing discharge and the sustaining discharge are under the influence of the operating voltage. FIG. 3B schematically shows the discharge dent essential to lower and stabilize the voltage at the start of the sustaining discharge. In the sustaining discharge, the discharge occurs by applying rectangular voltage pulse between scan electrode 5 and sustain electrode 6. At this time, the discharge occurs in the areas close to discharge gap 20 of the two electrodes. The areas require to having enough aging, i.e., the surfaces of the protecting layer in the areas have to be well sputtered; otherwise, the surfaces of the areas would undergo sputtering in the sustaining discharge in the panel operation, as well as in the aging process, and the shape of the surfaces is altered by the undesired sputtering. The change in shape of the surface invites variations in voltage of sustaining discharge, resulting in poor display characteristics. To protect the panel from inconveniencies above, the aging process should be performed so as to focus on the area close to discharge gap 20 in scan electrode 5 and sustain electrode 6. Compared to the discharge dent of the area on the side of adjacent gap 21, the discharge dent of the area on the side of discharge gap 20 has to have an enough depth so as to minimize the change in shape of the surface of the protecting layer in the panel operations. In other words, for obtaining the stability of the sustaining discharge, the area on the side of adjacent gap 21 is not necessarily to have a deep discharge dent by a strong aging.

On the other hand, FIG. 3C schematically shows the discharge dent essential to lower and stabilize the voltage at the start of the writing discharge. The writing discharge occurs between scan electrode 5 and data electrode 10. To obtain stability of voltage in the writing discharge in panel operation, it is preferable that the entire area on the side of scan electrode 5 facing data electrode 10 undergoes aging so as to have uniform discharge dent by entire sputtering. That is, as far as the writing discharge is concerned, the aging on the side of sustaining electrode 6, i.e., forming the discharge dent on that side has not much importance.

Therefore, in order to stabilize both of the sustaining, and writing discharges, the aging should preferably be performed on the area that covers both the diagonally shaded areas in FIGS. 3B and 3C—the area shown in FIG. 3A. Although the area on the side of discharge gap 20 of scan electrode 5 undergoes both the sustaining discharge and writing discharge, the area has no need to have a discharge dent deeper than the area on the side of adjacent gap 21 of identical scan electrode 5. The aging should be uniformly performed on the entire area on the side of scan electrode 5. On the contrary, an excessive aging on the area on the side of discharge gap 20 not only shortens the life of a panel, but also increases unnecessary electric power.

FIG. 3D schematically shows a depth distribution of the discharge dent formed on the panel of the embodiment. According to the aging of the embodiment, the discharge dent is formed so as to have a distribution with continuous and gradual change shown in FIG. 3D, instead of a “two-valued” distribution shown in FIG. 3A. The discharge dent on the side of sustain electrode 6 is so formed that the depth of the discharge dent in the area away from scan electrode 5 paired with sustain electrode 6 as the counterpart of a display electrode is shallower than the depth in the area close to counterpart scan electrode 5.

As described above, performing a minimum amount of aging on a necessary area can minimize sputtering to protecting layer 8, thereby increasing the life of the panel. As additional plus, the aging time can be shortened, with the efficiency of electric power increased.

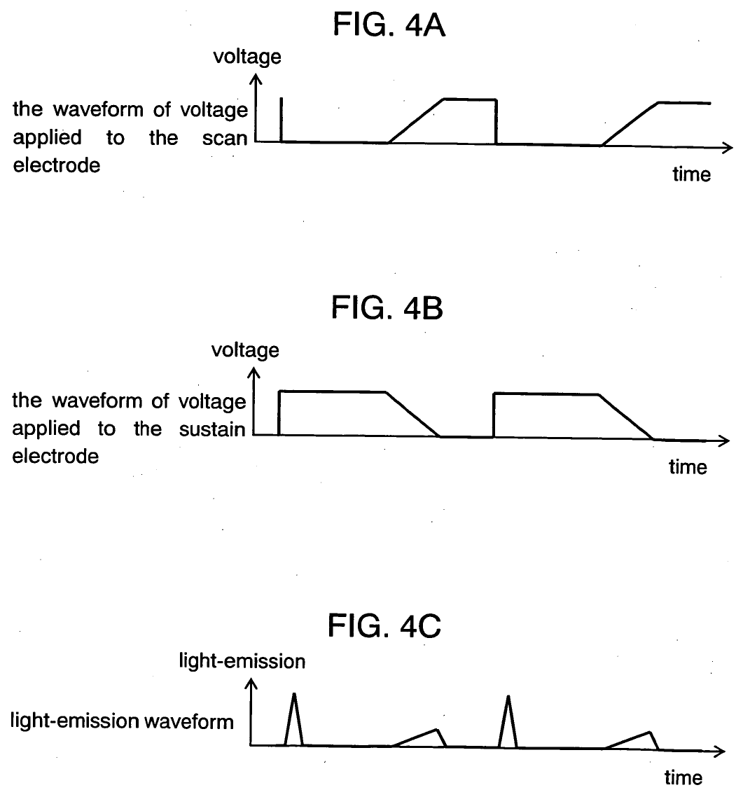

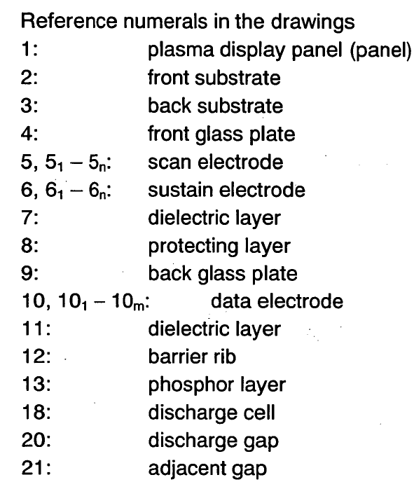

FIGS. 4A and 4B show examples of aging waveforms to form an asymmetric discharge dent of the embodiment. As shown in the figures, a voltage having an alternate voltage component is applied between scan electrode 5 and sustain electrode 6. The voltage applied to scan electrode 5 exhibits, as shown in FIG. 4A, a leading edge having a mild slope and a precipitous trailing edge. In contrast, the voltage applied to sustain electrode 6 has a precipitous leading edge and a mild trailing edge, as shown in FIG. 4B. Although the leading edge of the voltage waveform for scan electrode 5 and the trailing edge of the waveform for sustain electrode 6 have a mild slope in the embodiment, it is not limited thereto; either one of them may exhibit a mild slope. The voltage waveform applied to data electrode 10 is not shown in the figure. Data electrode 10 may be placed no voltage, or may be connected to a ground.

FIG. 4C schematically shows light emission of a panel in the form of a waveform detected by a photo sensor according to the embodiment. As is apparent. from the figure, a strong discharge occurs in response to a steep change in voltage and a weak discharge occurs at a mild change in voltage. In the aging waveform, when the strong discharge occurs, positive ions attracted to scan electrode 5 as the cathode cause a strong sputtering on the surface of protecting layer 8. On the other hand, sustain electrode 6 collects electrons; however, an electron has small mass. Therefore, a strong sputtering never occur on the surface on the side of sustain electrode 6. The weak discharge following the strong discharge is the discharge localized around discharge gap 20. In the discharge, positive ions, which are attracted to sustain electrode 6 close to discharge gap 20, cause a strong sputtering on the surface of protecting layer 8. The repeatedly caused sputtering is believed to be forming the discharge dent shown in FIG. 3A.

As described above, by generating a relatively strong discharge when the voltage waveform applied to scan electrode 5 has the trailing edge (i.e., when scan electrode 5 acts as cathode); on the other hand, generating a relatively weak discharge when the voltage waveform applied to sustain electrode 6 has the trailing edge (i.e., when sustain electrode 6 acts as cathode), the discharge dent shown in FIG. 3 can be formed. However, excessively strong discharge, which is brought by application of increased voltage to the electrodes, is not desired in the aging process. Through such a too strong discharge, the depth of the discharge dent on the side of adjacent gap 21 is inconveniently deeper than that of the discharge dent on the side of discharge gap 20. According to the embodiment, the optimum voltage is experimentally determined at 210V. The optimum voltage highly depends on the electrode structure and the material of a panel; the voltage value should be optimized to each panel.

Prior to the actual panel operation, a panel has to undergo the aging process so as to operate with stability in the sustaining discharge and the writing discharge—two main discharge in an AC type 3-electrode PDP. According to the embodiment, a desired discharge dent, as shown in FIG. 3A, can be formed on the surface of protecting layer 8 by performing a minimized aging. Conversely, designing the aging waveform and aging device so as to form the discharge dent of FIG. 3A allows a panel to have a long life.

The plasma display panel of the present invention has a long operating life by virtue of a minimized discharge dent.

### INDUSTRIAL APPLICABILITY

The present invention introduces a panel having a minimal amount of discharge dent and an aging method of forming the minimized discharge dent on a panel. The method is effective in aging an AC type plasma display panel, and the panel processed by the method provides a long lasting quality.

1. A plasma display panel in which a dielectric layer is disposed so as to cover a display electrode formed of a pair of a scan electrode and a sustain electrode, and a protecting layer is formed on the dielectric layer, and the plasma display panel in which an aging discharge is performed so as to form a discharge dent on the protecting layer by applying voltage having an alternate voltage component at least between the scan electrode and the sustain electrode, wherein the discharge dent on the side of the sustain electrode has a width narrower than the discharge dent on the side of the scan electrode.

2. A plasma display panel in which a dielectric layer is disposed so as to cover a display electrode formed of a pair of a scan electrode and a sustain electrode, and a protecting layer is formed on the dielectric layer, and the plasma display panel in which an aging discharge is performed so as to form a discharge dent on the protecting layer by applying voltage having an alternate voltage component at least between the scan electrode and the sustain electrode, wherein, as for the discharge dent formed on the sustain electrode-side, the discharge dent formed in an area away from the scan electrode paired with the sustain electrode as the display electrode has a depth shallower than the discharge dent formed in an area close to the scan electrode paired with the sustain electrode as the display electrode.

3. A method of aging a plasma display panel having a scan electrode, a sustain electrode, and a data electrode, the aging method having an aging process in which an aging discharge is performed by applying voltage having an alternate voltage component at least between the scan electrode and the sustain electrode, wherein at least any one of a leading edge of a waveform of voltage applied to the scan electrode and a trailing edge of a waveform of voltage applied to the sustain electrode has a mild slope.
